(19) United States
(12) Patent Application Publication
(10) Pub. No.: US 2009/0007701 A1
(43) Pub. Date: Jan. 8, 2009

(54) PIVOTING PIPETTE DEVICE

(76) Inventors: Peter T. Hadjis, Vernon Hills, IL (US); Christopher J. Stvartak, Skokie, IL (US); Michael F. De Rossi, Lindenhurst, IL (US); Sapta Gireesh Pudipeddi, Carpentersville, IL (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 11/772,943

(22) Filed: Jul. 3, 2007

(51) Int. Cl. B01L 9/00; B01L 3/02

(52) U.S. Cl. 73/864.01

(57) ABSTRACT

A pipette holder for retaining a pipette at a plurality of angles relative to the holder includes a first housing portion and a second housing portion wherein the second housing portion supports the pipette. The pipette device also includes a pivot mechanism pivotally coupling the first housing portion and the second housing portion.

### BACKGROUND

The present invention relates to a laboratory device, and in particular, to an adjustable pipette device for aspirating and dispensing liquids.

Persons performing low-impact, repetitive tasks such as word processing sometimes report pain and/or discomfort in the hands, arms, and neck. Doctors now diagnose such debilitating pain and discomfort as carpal tunnel syndrome or other cumulative trauma disorder (CTD), or repetitive stress injury (RSI). Ergonomic disorders, such as the aforementioned, have spawned a multi-billion dollar industry intending to maximize worker productivity by providing comfortable workstations, chairs, and computer hardware, thereby minimizing fatigue and discomfort.

Despite the advances of ergonomics for the office environment, in a laboratory setting, such as a medical laboratory, laboratory technicians are still subjected to repetitive operations with sub-optimal ergonomic devices, such as pipette devices. Pipetting is the act of aspirating and dispensing controlled volumes of liquid, and is one of the most frequently performed repetitive lab operations. Attempts to minimize the occurrences of RSIs in the lab have focused on training technicians in body mechanics (e.g., posture, pipetting technique, etc.), and providing an ergonomic pipette device.

The design of a pipette device is as important as the manner in which it is used. Pipette manufacturers recognize the benefits of an ergonomic pipette device, as is evidenced by the number of different ergonomic devices available. For example, many devices include a contoured handgrip to allow for a relaxed hold on the device. However, a contoured handgrip is not sufficient to completely obviate the development of an RSI or CTD in awkward, confined or restricted spaces, such as pipetting at lowered benchtops or in fume hoods where arm, joint or tendon strain may occur. Healthy technicians will not only have better attendance and attitude, but will also perform better with improved pipetting accuracy and precision. Therefore, in view of the foregoing, a need exists for an adjustable ergonomic pipette device.

### SUMMARY

In one embodiment, the invention provides a pipette holder for retaining a pipette at a plurality of angles relative to the holder. The pipette holder includes a first housing portion, a second housing portion supporting the pipette, and a pivot mechanism pivotally coupling the first housing portion and the second housing portion.

In another embodiment, the pipette holder includes a housing including a first portion and a second portion and a nozzle assembly for accepting a pipette, the nozzle assembly coupled to the second portion of the housing. The pipette holder also includes a pivot mechanism for coupling the first portion of the housing and the second portion of the housing to permit the second portion to pivot relative to the first portion.

In yet another embodiment, the pipette holder includes a housing including a first portion and a second portion pivotally coupled together and a pipette retaining member located on the second portion of the housing. The pipette holder also includes an indexing system on te housing for adjusting a pivot angle of the second portion relative to the first portion.

Other aspects of the invention will become apparent by consideration of the detailed description and accompanying drawings.

### BRIEF DESCRIPTION OF THE DRAWINGS

FIG. 1 illustrates a side perspective view of a pipette device according to one embodiment of the invention, and including an attached pipette.

FIG. 2 is a side view of the pipette device shown in FIG. 1 illustrating a pivot range for a barrel portion of the device relative to a handgrip portion.

FIG. 3 is a top view of the pipette device shown in FIG. 1.

FIG. 4 is an exploded view of the pipette device shown in FIG. 1.

FIG. 5 is a perspective view of a first housing of the handgrip portion and illustrates an inner surface of the housing.

FIG. 5A is an enlarged side view of an upper edge of the housing shown in FIG. 5.

FIG. 6 is a perspective view of a second housing of the handgrip portion and illustrates an inner surface.

FIG. 7 is a perspective view of a first housing of the barrel portion and illustrates an outer surface.

FIG. 7A is an enlarged side view of the housing shown in FIG. 7.

FIG. 8 is a perspective view of a second housing of the barrel portion.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

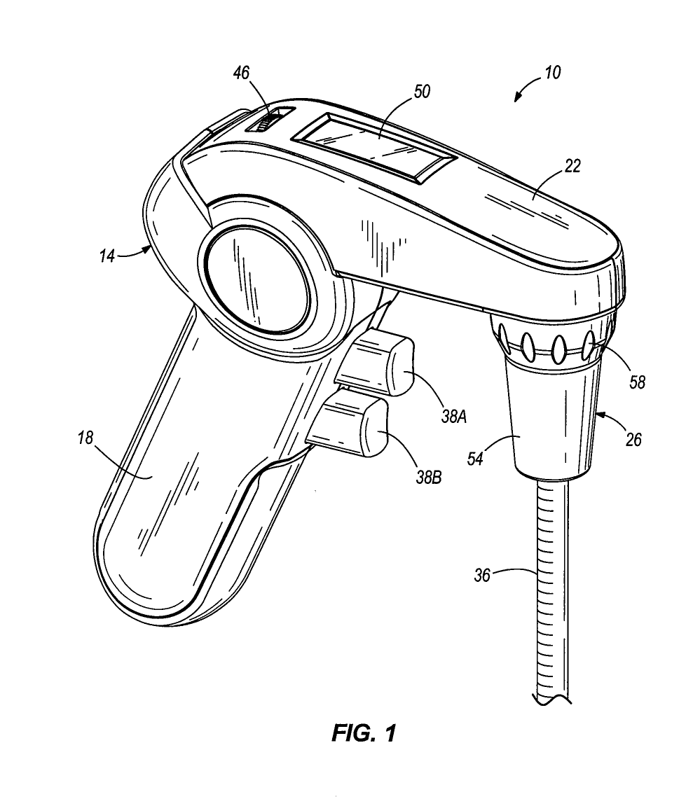

Referring to FIGS. 1-4, one embodiment of a pipette device 10 is shown. The pipette device 10 includes a generally pistol-shaped housing 14, although other shapes are suitable for the housing 14. The housing 14 may be constructed of any suitable material known in the art; however, in the illustrated embodiment, the housing 14 is constructed of a plastic material molded or otherwise formed into four pieces that are secured together. In one embodiment, the housing 14 includes an external matte finish that provides a non-slip surface for improved gripping and handling of the pipette device 10.

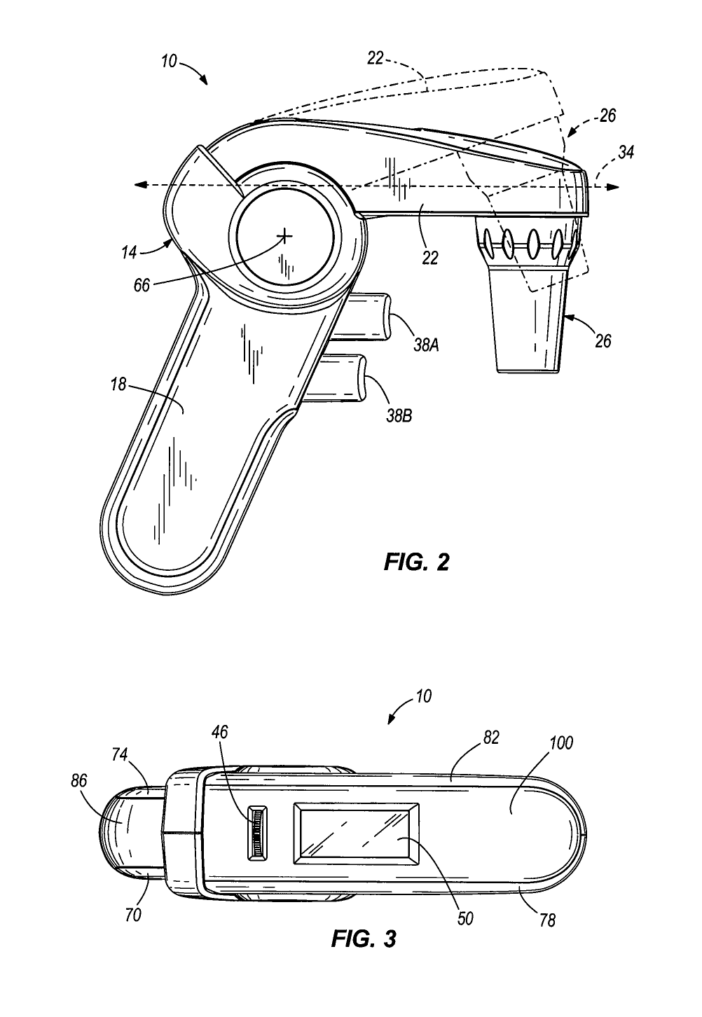

The housing 14 includes a handgrip portion 18, a barrel portion 22, and a nozzle assembly 26. The handgrip portion 18 and the barrel portion 22 are each formed from a pair of opposed housings coupled together. To those in the art, such pipette devices are referred to as pipetting aids or pipette guns. During typical use of the pipette device 10, the barrel portion 22 is oriented substantially parallel with a horizontal work surface (e.g., table, benchtop, etc.). In this way, a device axis 34 (FIG. 2) is defined through the pipette device 10, which is generally horizontal during typical use, but may be oriented otherwise for a user's comfort. The nozzle assembly 26 is operable to releasably retain glass and plastic pipettes 36 of various sizes and volumes. Additionally, as discussed in further detail below, the barrel portion 22 may be pivoted relative to the handgrip portion 18 (e.g., towards and away from the horizontal work surface or transverse to the device axis 34) to reduce arm strain during pipetting. Advantageously, the handgrip portion 18 includes an ergonomic treatment to reduce hand strain and is hand-neutral (i.e., usable by both right-handed and left-handed users).

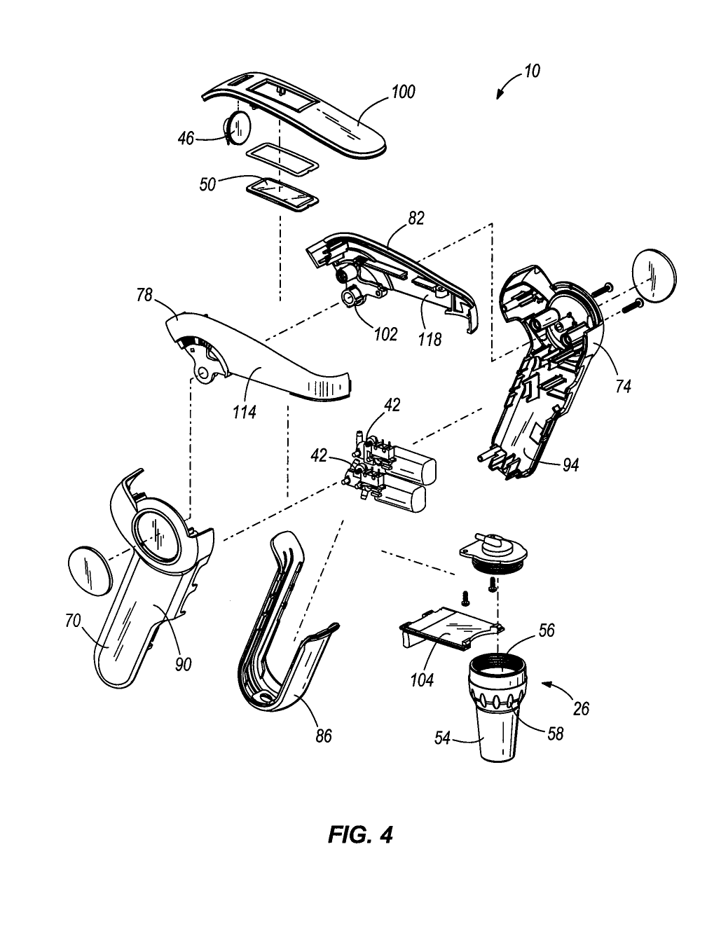

Trigger buttons 38A, 38B project through a portion of the handgrip portion 18. The buttons 38A, 38B are positioned for actuation by a user's fingers and may include an ergonomic treatment, such as a curved, concave, or contoured end surface, for reducing finger fatigue. Furthermore, the end surface of each button 38A, 38B may include a button-identifying portion such as an indent or protrusion that provides a user with a tactile means for telling the buttons 38A, 38B apart. The buttons 38A, 38B activate the device to aspirate and dispense fluid, respectively. Referring to FIG. 4, the buttons 38A, 38B actuate microswitches or the like on a circuit board to operate a reversible motorized pump mechanism (not shown), such as a vacuum pump or the like. The pump mechanism applies a positive or negative pressure to an attached pipette 36 via one of the variable valve assemblies 42 and connective flexible tubing (not shown) within the housing 14. A continuous speed dial 46 accessible from the barrel portion 22 is linked to the circuit board to select the speed of the pump mechanism depending on the user's desired pipetting speed and precision. Additionally, the pump mechanism is energized by one or more batteries (not shown), which are rechargeably linked to a power jack. An LCD screen 50 in the barrel portion 22, and positioned proximate the speed dial 46, provides an indication of the speed setting and the battery charge of the pipette device 10.

The nozzle assembly 26 is rigidly held by and located at one end of the barrel portion 22 opposite the handgrip portion 18. The nozzle assembly 26 includes a nozzle housing 54 having a generally frustoconcical shape and a central bore 56 therethrough. The exterior of the nozzle 54 may include gripping detents 58 that facilitate disassembly of the nozzle assembly 26 for filter replacement, cleaning, autoclaving, or the like. Although not shown, the nozzle assembly 26 includes a number of elements engaged within the nozzle housing 54 to provide a continuous positive or negative pressure path between the attached pipette 36 and the pump mechanism. It should be readily apparent to those of skill in the art that other known nozzle assemblies may be used with the pipette device.

The pipette device 10 includes a pivot mechanism 62, about a pivot axis 66 (FIG. 2), or pivot point, to selectively pivot the barrel portion 22 relative to the handgrip portion 18 to reduce arm strain during pipetting. Referring to FIGS. 4-8, the housing 14 of the pipette device 10 is formed from a first handgrip housing 70, a second handgrip housing 74, a first barrel housing 78, and a second barrel housing 82. The first and second handgrip housings 70, 74 are of substantially similar size and shape, and are coupled together with an intermediate housing 86 to define the handgrip portion 18. Each of the handgrip housings 70, 74 includes an outer surface 90 and an inner surface 94. A pivot boss 98 extends outwardly from the inner surface 94 of each handgrip housing 70, 74 to define the pivot axis 66 of the pipette device 10. The pivot bosses 98 are sized and shaped to snugly fit within pivot sleeves 102 on the barrel housings 78, 82. The inner surface 94 of each handgrip housing 70, 74 also includes a number of bosses, sleeves, extensions and recesses to mate with structure on the opposed handgrip housing 74, 70.

The first and second barrel housings 78, 82 are of substantially similar size and shape, and are coupled together with an upper housing 100 and a lower housing 104 to define the barrel portion 22. First ends 106 of the barrel housings 78, 82 support the nozzle assembly 26, and second ends 110 of the barrel housings 78,82 fit within a first end of the handle portion 18 for pivotally coupling the barrel portion 22 to the handle portion 18. Each barrel housing 78, 82 includes an outer surface 114 and an inner surface 118. A pivot sleeve 102 extends from the inner surface 118 of each barrel housing 78, 82 to further define the pivot axis 66 of the pipette device 10. The pivot sleeves 102 are sized and shaped to snugly receive the pivot bosses 98 of the handgrip housings 70, 74. The inner surface 118 of each barrel housing 78, 82 also includes a number of bosses, sleeves, extensions and recesses to mate with structure on the opposed barrel housing 82, 78. The pivot bosses 98 and the pivot sleeves 102 define the pivot axis 66 about which the barrel portion 22 pivots transverse to the device axis 34 (FIG. 2).

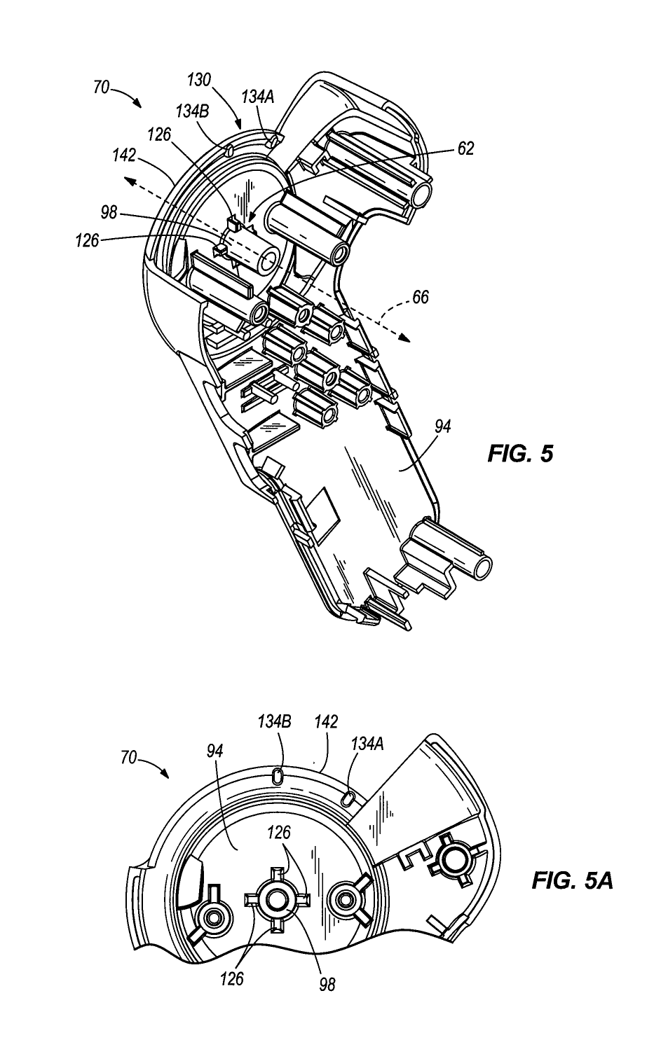

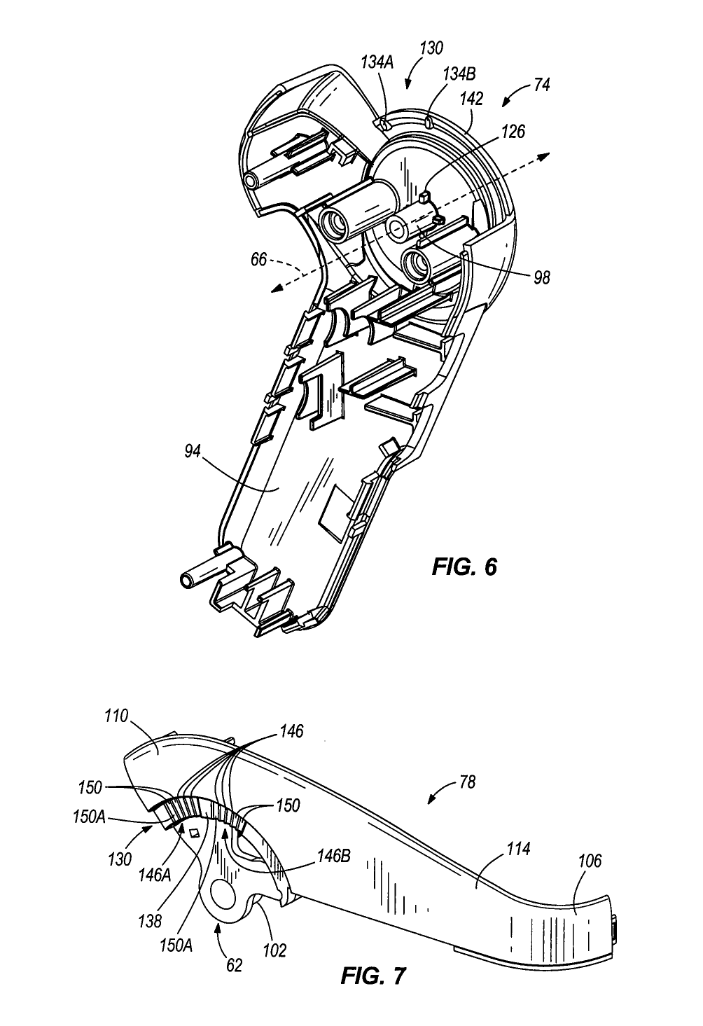

The pivot bosses 98 and pivot sleeves 102 may be cylindrically, frustoconically, or otherwise shaped to permit rotation. In the illustrated embodiment, the bosses 98 of the handgrip housings 70, 74 include projecting extensions 126 (FIGS. 5-6) to provide a more tolerant fit in the sleeves 102. The sleeves 102 and the bosses 98 are rotatably engaged to adjustably pivot the barrel portion 22 about the pivot axis 66 and to change its angular position to the handgrip portion 18. Although the illustrated pivot axis 66 is transverse to the device axis 34, the pivot mechanism 62 and pivot sleeves 122 may be arranged alternatively so the axes 34, 66 are oriented in parallel, obliquely, or otherwise to achieve a desired pivoting of the nozzle assembly 26. Moreover, the pipette device 10 may alternatively include, for example, a swivel, ball, joint, articulation, ball-in-socket, or other like means for providing angular adjustability in a variety of directions. Furthermore, the pipette device 10 may include a locking means to lock, clamp, or otherwise inhibit adjustment of the swivel, ball, joint, articulation, ball-in-socket, or the like to retain the barrel portion 22 in a desired position. The locking means may include, for example, a pin, screw, clamp, vise, or other fastening means known in the art.

Referring to FIG. 2, the barrel portion 22 is pivotable throughout a range of approximately 20° relative to the device axis 34, with five discrete resting positions spaced approximately 5° apart. The pivoting mechanism 62 of the pipette device 10 includes an indexing system 130 to hold the barrel portion 22 in one of the discrete positions relative to the handgrip portion 18. The indexing system 130 includes indexing posts 134A, 134B positioned on the inner surfaces 94 of the handgrip housings 70, 74 and an indexing surface 138 positioned on the outer surfaces 114 of the barrel housings 78, 82. The posts 134A, 134B engage the surface 138 to hold the barrel portion 22 in a desired position.

The inner surface 94 of each handgrip housing 70, 74 includes a pair of indexing posts 134A, 134B (FIG. 5A) extending toward the opposed barrel housing 78, 82. The indexing posts 134A, 134B are positioned radially outward from the pivot boss 98, i.e., the pivot axis 66, along an upper edge 142 of the handgrip housing 70, 74. FIG. 5A shows an enlarged view of the upper edge 142 of the first handgrip housing 70, and referring to FIG. 6, the upper edge 142 of the second handgrip housing 74 is generally a mirror image of the first handgrip housing 70. In the illustrated embodiment, two indexing posts are shown; however, it should be readily apparent to those of skill in the art that in further embodiments fewer or more posts may be used.

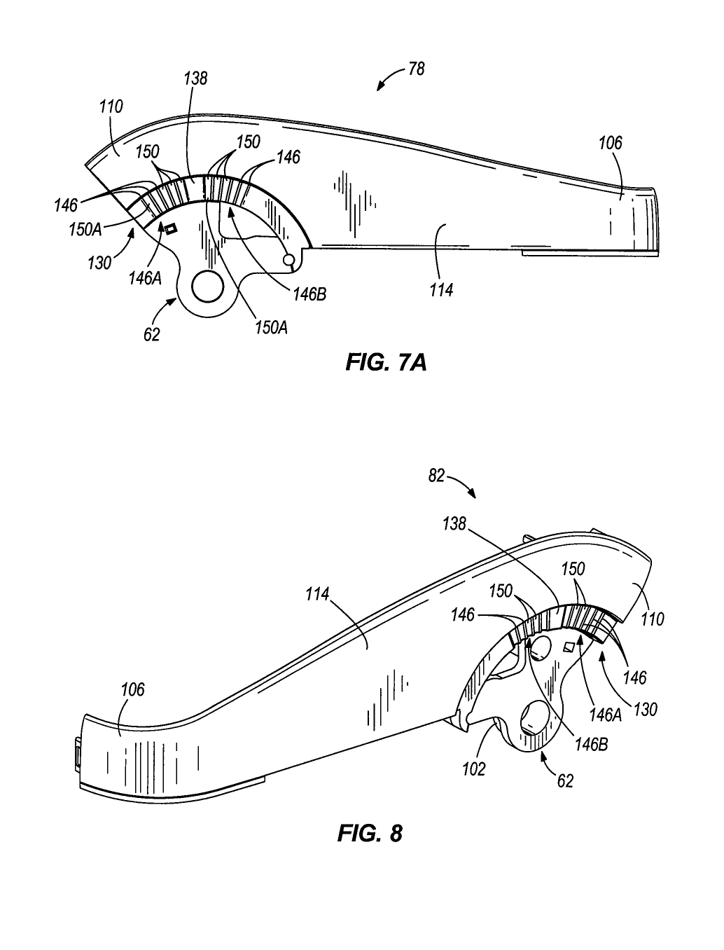

The outer surface 114 of each barrel housing 78, 82 includes the indexing surface 138 (FIG. 7A), which is recessed with respect to the outer surface 114. The indexing surface 138 is generally arc-shaped and positioned radially outward from and centered about the pivot sleeve 102, i.e., the pivot point 66. The indexing surface 138 includes a plurality of ridges 146 spaced apart to define indents 150 between adjacent ridges. Each indent 150 corresponds to a resting position for the opposed indexing post 134A, 134B. In the illustrated embodiment, the indexing surface 138 includes two groups 146A, 146B of six ridges each such that each group 146A, 146B defines five indents 150, i.e., resting positions. Each indexing post 134A, 134B operates in conjunction with one group 146A, 146B of ridges. FIG. 7A shows an enlarged view of the indexing surface 138 of the first barrel housing 78, and referring to FIG. 8, the indexing surface 138 of the second barrel housing 82 is generally a mirror image of the first barrel housing 78. It should be readily apparent to those of skill in the art that in further embodiments fewer or more ridges and indents may be formed in the indexing surface 138 and that a single group of ridges or multiple groups of ridges may be used to form the indexing system 130.

When the pipette device housing 14 is assembled, the indexing posts 134A, 134B of the first handgrip housing 70 mate with the indexing surface 138 of the first barrel housing 78, and the indexing posts 134A, 134B of the second handgrip housing 74 mate with the indexing surface 138 of the second barrel housing 82. The ridges 146 associated with the first ridge group 146A of each barrel housing 78, 82 slide over the first indexing post 134A of the respective handgrip housing 70, 74, and the ridges 146 associated with the second ridge group 146B of each barrel housing 78, 82 slide over the second indexing post 134B of the respective handgrip housing 78, 82. The indexing system 130 operates similarly to a ratchet and pawl as the barrel portion 22 is pivoted between resting positions. It should be readily apparent to those of skill in the art that in further embodiments, the barrel portion 22 may have a larger or smaller pivot range and may include fewer or more resting positions. In a further embodiment, the indexing posts may be located on the barrel portion 22 and the indexing surface may be located on the handgrip portion 18.

Referring to FIGS. 2, 5A and 7A, when the barrel portion 22 is positioned at an initial position, the indexing posts 134A, 134B are retained within the opposed indents 150 at an endmost position 150A of the opposed ridge group 146A, 146B. To move the barrel portion 22 to another position, a user holding the handgrip portion 18 places sufficient pressure on the barrel portion 22 to overcome the frictional engagement, disengage the indexing posts 134A, 134B from the associated indents 150 and rotate the barrel portion 22 relative to the handgrip portion 18. The ridges 146 slide over the indexing posts 134A, 134B of the associated handgrip housing 70, 74 until the barrel portion 22 reaches a desired angular position relative to the handgrip portion. Once the barrel portion 22 reaches the desired position, the indexing posts 134A, 134B frictionally engage the associated indents 150 to hold the barrel portion 22 in position.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A pipette holder for retaining a pipette at a plurality of angles relative to the holder, the pipette holder comprising:
a first housing portion;
a second housing portion wherein the second housing portion supports the pipette; and
a pivot mechanism pivotally coupling the first housing portion and the second housing portion.

2. The pipette holder of claim 1, and further comprising a holder axis that is generally horizontal during use, and wherein the pivot mechanism comprises:
a pivot boss extending from the first housing portion and defining a pivot axis about which the second housing portion pivots, wherein the pivot axis orients generally transversely to the holder axis; and
a pivot sleeve extending from the second housing portion and receiving the pivot boss.

3. The pipette holder of claim 1 wherein the second housing portion is pivotable through a range of approximately 20°.

4. The pipette holder of claim 3 wherein the pivot mechanism provides more than two positions for the second housing portion.

5. The pipette holder of claim 1 wherein the pivot mechanism includes an indexing system to hold the second housing portion in a plurality of positions.

6. The pipette holder of claim 5 wherein the indexing system comprises:
a post extending from the first housing portion; and
a plurality of indents formed on the second housing portion and opposed from the post, wherein each indent defines one of the plurality of positions,
wherein the post frictionally engages one of the plurality of indents.

7. The pipette holder of claim 1 wherein the first housing portion comprises a pair of opposed first sections and the second housing portion is disposed between the first sections.

8. The pipette holder of claim 7 wherein the pivot mechanism includes nesting cylinders pivotally coupling the second housing portion with the first sections and defining a generally horizontal pivot axis about which the second housing portion rotates.

9. A pipette holder for retaining a pipette at a plurality of angles relative to the holder, the pipette holder comprising:
a housing including a first portion and a second portion;
a nozzle assembly for accepting a pipette, the nozzle assembly coupled to the second portion of the housing; and
a pivot mechanism coupling the first portion of the housing and the second portion of the housing to permit the second portion to pivot relative to the first portion.

10. The pipette holder of claim 9 wherein the pivot mechanism comprises:
a pivot boss extending from the first portion and defining a pivot axis about which the second portion pivots; and
a pivot sleeve extending from the second portion and receiving the pivot boss.

11. The pipette holder of claim 9 wherein the second portion is pivotable through a range of approximately 20°.

12. The pipette holder of claim 11 wherein the pivot mechanism provides more than two positions for the second portion.

13. The pipette holder of claim 9 wherein the pivot mechanism includes an indexing system to hold the second portion in a plurality of positions.

14. The pipette holder of claim 13 wherein the indexing system comprises:
a post extending from the first portion; and
a plurality of indents formed on the second portion and opposed from the post, wherein each indent defines one of the plurality of positions,
wherein the post frictionally engages one of the plurality of indents.

15. The pipette holder of claim 14, and further comprising a ridge separating each of the plurality of indents.

16. A pipette holder for retaining a pipette at a plurality of angles relative to the holder, the pipette holder comprising:
a housing including a first portion and a second portion pivotally coupled together;
a pipette retaining member located on the second portion of the housing; and
an indexing system on the housing for adjusting a pivot angle of the second portion relative to the first portion.

17. The pipette holder of claim 16 wherein housing comprises a pivot sleeve and a pivot boss rotatably retained.

18. The pipette holder of claim 17 wherein the indexing system comprises a first post extending from the first portion of the housing and an indexing surface located on the second portion of the housing, the indexing surface engageable with the first post.

19. The pipette holder of claim 18 wherein the indexing surface includes a plurality of indents, and each indent defines a possible receiving position for the first post.

20. The pipette holder of claim 19, and further comprising a second post extending from the first portion of the housing, the second post engaging an indent different than the indent engaged by the first post.

21. The pipette holder of claim 20 wherein the first and second posts are positioned radially outward from the pivot boss.

22. The pipette holder of claim 18 wherein the indexing surface is arcuately shaped.
